(19) United States
(12) Patent Application Publication
(10) Pub. No.: US 2004/0221902 A1
(43) Pub. Date: Nov. 11, 2004

(54) Microfluidic mixing using flow pulsing

(76) Inventors: Nadine N. Aubry, Metuchen, NJ (US); Ian K. Glasgow, Averill Park, NY (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/839,948

(22) Filed: May 6, 2004

Related U.S. Application Data
(60) Provisional application No. 60/468,241, filed on May 6, 2003.

(51) Int. Cl. G05D 7/03

(52) U.S. Cl. 137/826

(57) ABSTRACT

A method of mixing two or more fluids comprising pulsing the flow of two fluids selected from the two or more fluids, reversing the flow of one of the pulsed fluid, bringing into contact the fluids and causing them to mix. A device for mixing the fluids is also provided.

### CROSS-REFERENCE TO RELATED APPLICATION

This application claims benefit of U.S. provisional patent application Ser. No. 60/468,241, filed May 6, 2003, which is herein incorporated by reference.

### FIELD THE INVENTION

The present invention relates to processes for mixing between two or more fluids. The present invention also relates to devices for such mixing. The processes and devices of the invention are useful in various biological and chemical systems.

### BACKGROUND OF THE INVENTION

There has been a growing number of applications for microfluidic systems in technical areas such as chemical and biological synthesis, chemical and biochemical analysis, and environmental monitoring to name a few. One advantage of the use of microfluidic systems is that complex reactions can be carried out in very small volumes of fluid and in a single integrated device. Another advantage is that microfluidic systems increase the reaction response time and help to reduce reagent consumption.

Microfluidic systems, referred to as “Lab-on-a-Chip,” have been associated with the regulation, transport, mixing and storage of very small quantities of liquid rapidly and with the ability to carry out desired physical, chemical, and biochemical reactions in larger numbers. Therefore, one issue facing a lab-on-a-chip device is the movement and mixing in a controlled fashion of multiple fluids.

Applying conventional mixing techniques to microfluidic volumes is generally ineffective, impractical, or both. Microfluidic systems are characterized by extremely high surface-to-volume ratios and correspondingly low Reynolds numbers for most achievable fluid flow rates. At such low Reynolds numbers, fluid flow within most microfluidic systems is squarely within the laminar regime, and mixing between fluid streams is motivated primarily by the phenomenon of diffusion which is typically a relatively slow process. In the laminar flow regime, the use of conventional geometric modifications such as baffles is generally ineffective to promote mixing. Moreover, the task of integrating moveable stirring elements can be prohibitively difficult using conventional means due to volumetric and physical constraints and cost consideration.

Current microfluidic mixing methods utilize complex geometries, intricate assembly and elaborate fabrication methods, external fields which mix fluids using ultrasonics, electrokinetics, electroosmosis and dielectrophoresis (in fluids with particles) induced by an AC electric field, and magneto hydrodynamics. Electro-osmotic flow in conjunction with a serpentine main channel and a series of “short cut” tributaries has been utilized. Complex geometries that decrease diffusion distances include multilamination techniques which split and rearrange channels or rearrange flow paths, and an array of inlets orthogonal to a wide, shallow channel. Complex geometries that induce secondary flow include a three-dimensional twisted pipe, oblique ribs along the floor of the channel, either slanted in one direction or embodied as a staggered series of asymmetric herringbone ribs, slanted trenches or a very shallow or narrow channel (Glasgow, I., and Aubry, N., Lab Chip, 2003, 3, pp. 114-120 and references cited therein).

Thus there exists a need for a process and system to enhance microfluidic mixing between two or more fluids in a microfluidic device that does not utilize complex geometries and that is reliable and easy to use.

### SUMMARY OF THE INVENTION

The present invention generally relates to mixing two or more fluids by flow pulsing and reversal. The invention also relates to devices for such mixing.

In one aspect of the invention, a method for mixing two or more fluids is provided. The method comprises the steps of applying a perturbation to a first fluid and a second fluid selected from the two or more fluids. The perturbation pulses and reverses the flow of the fluids. Following perturbation, the fluids are brought into contact with the remaining fluids and all the fluids mix. The perturbation to the first fluid may be in phase or out of phase with the perturbation to the second fluid. The perturbation to the first fluid and the perturbation to the second fluid may be at the same frequency or at different frequencies. The perturbation to the first fluid and the perturbation to the second fluid may be periodic or non-periodic. The perturbations may be pressure-induced, displacement-induced or electrically-induced perturbations.

In another one aspect of the invention, two fluids are mixed. Mixing occurs in a device comprising a first inlet channel which serves as a conduit for the first fluid, a second inlet channel which serves as a conduit for the second fluid, and a confluence region which is an intersection region of the first inlet channel and the second inlet and wherein the first fluid and the second fluid meet and mix. The confluence region is of substantially the same volume as the volumetric displacement of the fluids being mixed. The device also comprises an outlet channel in fluid communication with the confluence region which serves as a conduit for the mixed first fluid and second fluid. Coupled to the device is a means for applying the perturbation to the fluids.

These and other aspects and objects of the invention will be apparent to one skilled in the art upon review of the following detailed disclosure, drawings, and claims.

### BRIEF DESCRIPTION OF THE DRAWINGS

So that the manner in which the above recited features of the present invention can be understood in detail, a more particular description of the invention, may be had by reference to embodiments, some of which are illustrated in the Figures. It is to be noted, however, that the Figures illustrate only typical embodiments of this invention and are therefore not to be considered limiting of its scope, for the invention may admit to other equally effective embodiments.

FIG. 1 is an illustration of confluence geometries of a microfluidic device realized in accordance with the principles of the invention. FIG. 1(a) shows a perpendicular inlet channel geometry, FIG. 1(b) shows a Y channel geometry, FIG. 1(c) shows a T channel geometry, FIG. 1(d) shows an arrow channel geometry and FIG. 1(e) shows a channel geometry with more than one inlet channel and more than one outlet channel.

FIG. 2 is a schematic of a T channel device equipped with electrodes.

FIG. 3 is a schematic of the electric circuit applied to the channel device of FIG. 2.

FIG. 4 is an illustration of numerical results obtained when a constant mean velocity is applied to the fluids in both inlet channels of the device in FIG. 1(a).

FIG. 5 is an illustration of numerical results obtained when a pulse flow is applied to the perpendicular channel inlet of the device in FIG. 1(a).

FIG. 6 is an illustration of the numerical results obtained when the fluids in the two inlet channels of the device in FIG. 1(a) are pulsed at 90 degrees phase difference.

FIG. 7 is an illustration of numerical results obtained when the fluids in the two inlet channels of the device in FIG. 1(a) are pulsed at 180 degrees phase difference.

FIG. 8 is an illustration of the variation of the degree of mixing as a function of the cumulative volume for various Strouhal numbers and pulse volume ratios using the device of FIG. 1(c).

### DETAILED DESCRIPTION

The present invention is directed to processes for microfluidic mixing between two or more fluids. The processes of the invention employ a microfluidic device with at least two or more inlet channels and one or more outlet channels. The inlet channels intersect with each other and lead to one or more outlet channels through an inlet/outlet overlap zone or region of confluence. The inlet channels may be of the same or different width and depth. The width and depth of the outlet channels may be of the same or different width and depth as the inlet channels. The length of each channel may be at least the same as its width.

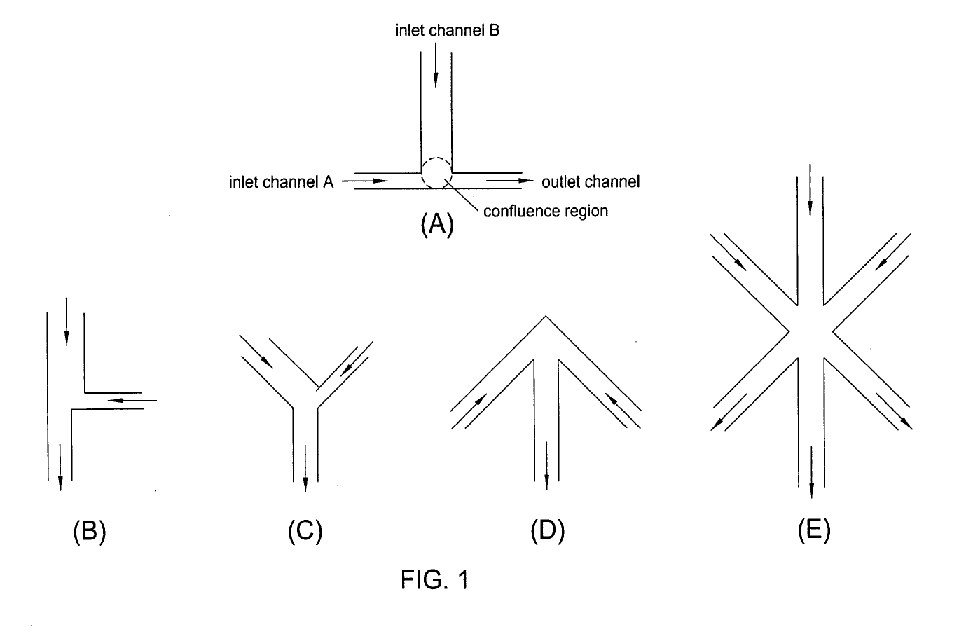

By way of illustration of the microfluidic device of the invention, FIG. 1(a) shows a perpendicular inlet channel microfluidic device featuring two inlet channels, a first inlet channel (inlet A) intersecting a second inlet channel (inlet B) and an outlet channel. The first inlet channel and the second inlet channel intersect at the confluence region which defines an intersection volume. Typical measurements of the device of FIG. 1(a) are from about 100 μm to about 800 μm channel width, and from 120 μm to about 500 μm channel depth. FIG. 1 also illustrates confluence geometries which find applicability in the invention. FIG. 1(b) shows a Y channel geometry, FIG. 1(c) shows a perpendicular inlet channel geometry, FIG. 1(d) shows an arrow channel geometry, and FIG. 1(e) shows a channel geometry with more than one inlet channel and more than one outlet channel. The geometry of the device contributes to the degree of mixing of the inlet fluids with the T channel geometry and the arrow channel geometry providing the most mixing.

Fluid mixing according to the invention can be accomplished by inducing a volumetric displacement in one or more inlet fluids. The volumetric displacement may be achieved by applying a perturbation to one or more inlet fluids. The perturbation results in the flow being displaced forward and backward and thus to the flow being pulsed. In addition to the flow being pulsed, the perturbation results in the direction of the flow being reversed. The perturbed fluid comprises the pulsed flow which is superimposed on the base flow,

FIG. 1(a) illustrates a device for mixing two inlet fluids. One or both of the inlet channels may be perturbed while reversing the flow of the fluid. Following perturbation and flow reversal, the fluids from each inlet channel flow together into the outlet channel. The flow of the fluid through each of the inlet channels can be pulsed and the flow reversed using several methods. One method includes varying the speed and reversing the direction of the pump which is delivering the fluid to the inlet channel. Reversal of the pump direction leads to a reversal of the fluid flow. Another method includes displacing the fluid in the inlet channel by varying the volume of the inlet channel in one or more passageways or tubing, or pump connected to the inlet channel. These and any other methods which cause pulsing and reversal of fluid flow are applicable to this invention.

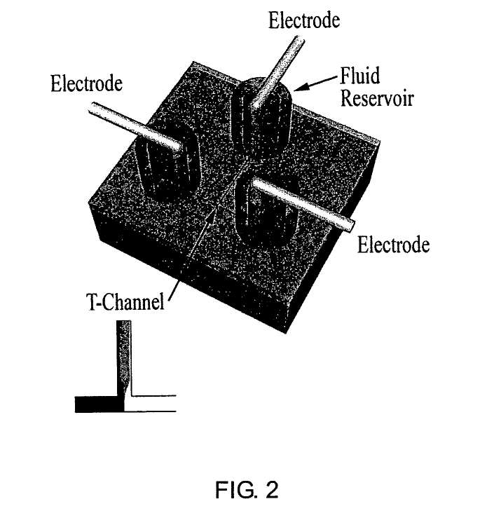

The rate of flow of the fluid through each of the inlet channels can also be varied with time by applying an electrical field and triggering an electrically-induced perturbation. An electrically-induced perturbation can be accomplished by applying a voltage across the inlet channels and outlet channel so that the electric field is substantially parallel to the direction of the fluid flow. This causes the charges in the electric double layers at the fluid/channel interface to travel in proportion to the voltage gradient and drive the flow of the fluid. As shown in FIG. 2, one or more electrodes can functionally be coupled to the inlet channel ports and to the outlet channel port. Coupling an electrode to the outlet channel port contributes to maintaining the base flow. The flow can be reversed by reversing the direction of the voltage applied. These and other methods which cause pulsing and reversal of the flow are applicable to this invention.

Fluid mixing is most efficient when the perturbations to the two inlet fluids are out of phase with each other. This can be accomplished if the perturbations from both inlets are at the same frequency but out of phase, if they occur at different frequencies, if they consist of multiple frequency components, if they are complex waveforms, or if one or both of the perturbations are not periodic, i.e. random. For example, the flow through both inlets could be at 10 Hz but 90 degrees out of phase with each other, possibly with the pulsing amplitude several times greater than the base flow. In this case, the total flow can be equated to the sum of the base flow which is the time averaged flow and a time varying flow whose magnitude is defined by the pulsing amplitude. Alternatively, one flow could vary at 10 Hz, the other at 15 Hz. Alternatively, one flow could vary at 10 Hz, the other could be a function of multiple frequencies, and/or magnitudes, such as the superposition of one wave at a given frequency with another wave at a different frequency and at the same or different amplitude. The waveforms include without limitation, sinusoidal, square, triangular and other waveforms.

Following perturbation, the fluids in the confluence region or intersection volume mix. The degree of mixing is dependent on a number of factors. The degree of mixing is a function of the base flow and of the pulsing perturbation, the Reynolds number, the viscosity and mass diffusivity of the fluid, the size of the channels, the geometry of the confluence region, the angle of intersection of the channels at the confluence region, the pulsing frequency and the pulsing phase. More specifically, the degree of mixing is dependent on the Strouhal number which is used to characterize fluidic systems where a frequency is present. The Strouhal number is the ratio of the flow characteristic time scale (L/V) to the pulsing time period (1/f), where L is the hydraulic diameter and V is the average velocity in the outlet channel, and is given by:

$$St = \frac{fL}{V} = \frac{( L / V )}{( 1 / f )} \qquad ( 1 )$$

The degree of mixing which is set forth in Equation (2) in the Summary section that follows is also dependent on the pulse volume ratio (PVR). Since volume displacement causes a pulse volume in the fluid, the magnitude of the pulse volume can be compared to the intersection volume. The ratio of the pulse volume to the intersection volume defines the PVR. The Examples below illustrate the dependence of the degree of mixing on the Strouhal number and on the PVR. A degree of mixing of at least 90% can be achieved with a PVR of about 1 to about 5 while maintaining a high Strouhal number and approaching a fully developed flow during each pulse.

To achieve a high degree of mixing, the volume of the pulsed flow is substantially of the same order of magnitude of or greater than the intersection volume. The pulse frequency is such that a unit volume of the fluid being pulsed is subjected to travel back and forth at least several times through the intersection region, as the fluid travels through the channels. The degree of mixing can improve as the pulse frequency increases provided that a fully developed state during each pulse is approached. The degree of mixing is also affected by the phase difference of the pulse between the two inlet fluids, with greater mixing occurring when the phase difference is 90 degrees than when it is 180 degrees.

The following examples are presented by way of illustration only and in no way do they limit the above-described embodiments.

### EXAMPLES

Numerical Simulations

Three-dimensional mixing was computed using computational fluid dynamics. The simulations were conducted using Fluent, a fluid dynamics software provided by Fluent Inc., (Lebanon, N.H.).

The models consisted of 1.25 mm of two inlet channels and 3 mm of a single outlet channel. All three channels were 0.2 mm wide by 0.12 mm deep. The computational domain is discretized with structured hexahedral meshes, with most of the cells having all sides about 10 μm sides (width, depth and height). The channels are 20 cells wide and 12 deep, (6 deep with a plane of symmetry at half the channel depth). The numerically computed velocities are found to be within 0.5% of analytically calculated values and mass fractions within 0.02 of values from a test model with a mesh five times smaller. The convergence limit is set so that velocities converged within 0.1% and mass fractions reached their asymptotic values within 2×10⁻⁶.

Since the mixing relies upon diffusion occurring as the interface moves throughout the cross-section of the channel, the diffusion is modeled. In order to quantify the mixing, the fluids from both inlet channels are selected to be identical but referred to as A and B. The velocity and mass fraction of each fluid are calculated in each computational cell over time. The extent of diffusion for progressively smaller values of the diffusion constant was computed.

The time step in the numerical simulations was set to 20 or 40 steps per cycle (i.e. 0.005 s for 5 Hz pulsing). Sequential images of level contours of the mass fraction of one reagent at particular cross-sections enabled the visualization of the shape of the interface between the two fluids which was changing during a cycle. Data which was collected after pulsing was fully established. For example, for pulsing at 5 Hz, the pulse cycle was observed and data was collected from 1.8 s through 2.0 s after pulsing started. In order to compare the various cases and evaluate the effectiveness of the mixing, the mass fraction at the center of each cell in a cross-section located at 0.5 mm or 2 mm beyond the confluence was recorded.

Physical Tests

The results of the numerical simulations reported in the Examples were verified by the physical tests set forth below.

Testing of the volumetric displacement on the fluid flow was conducted using a microchannel device fabricated by numerically controlled mill machining of trenches and through holes at the ends of the trenches in a thin, clear, colorless, acrylic plate. This thin plate was bonded to a more rigid, clear polycarbonate base plate with UV curing optical adhesive (e.g. NOA 72, Norland Products, Inc., Cranbury, N.J.). The through-holes in the thin plate overlapped with holes in the base plate. These base plate holes only extended to half the thickness of the base plate, and connected to cross-holes which emerged from the sides of the base plate, to which fluidic connections were made. A number one thickness glass cover slip bonded onto the acrylic plate, using the same adhesive, enclosed the trenches, thereby forming the microfluidic channels. Eighteen and twenty-five gage syringe needles (e.g. B-D Needles, Cole-Parmer Instrument Company, Vernon Hills, Ill.) were light press fit into these 0.46 and 1.19 mm diameter cross-holes. Bonding the joints with epoxy (e.g. Loctite E-OOCL, Henkel Loctite Corp., Rocky Hill, Conn.) ensured good seals and mechanical integrity.

Volumetric displacement was initiated using a peristaltic pump (e.g. P625/900, Instech Laboratories, Inc., Plymouth Meeting, Pa.). Vinyl tubing was connected via a pump to the microchannel device. Pumping caused two aqueous solutions to flow through a 0.4 mm inside diameter silicone rubber tubing, into the channels. Two signals from −1.2 V to +1.2 V dc control the pumping, from maximum reverse to maximum forward flow, respectively. The control signal comes from the center taps of potentiometers used as voltage dividers. A function generator sends a sinusoidal signal to one end of both voltage dividers and a power supply fixes the other ends of the voltage dividers to specified voltages. Fluid mixing is observed under a standard compound microscope and images are taken with a color video camera mounted to the microscope.

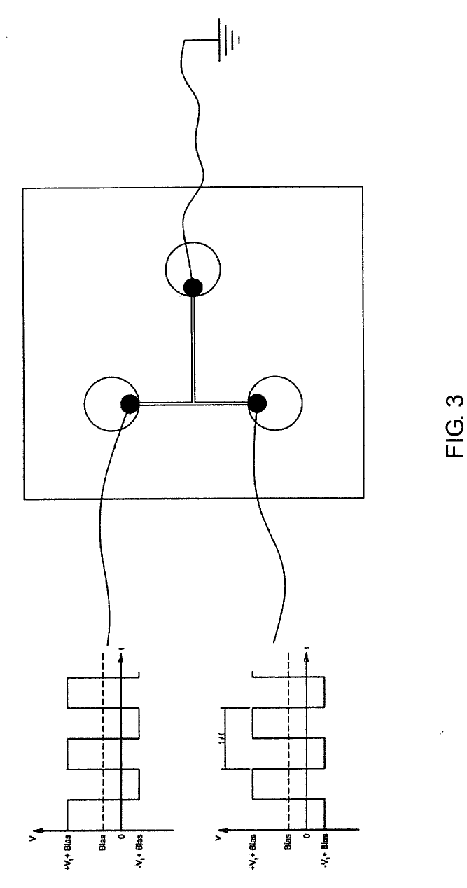

Volumetric displacement was initiated by an electric field, using the microchannel device of FIG. 2. A mean velocity flow was created with a superimposed pulsing flow to the fluid in the channel, a constant DC voltage with a superimposed alternating DC voltage was applied to 1 mm platinum electrodes placed in each of the wells. For the mean velocity flow, 60V DC batteries were connected to the electrodes (See Vₒ in FIG. 3). For the superimposed alternating DC voltage, two high voltage amplifiers (Trek Inc., NY) driven by a function generator, through a switched double pole double throw relay (DPDT) to the electrodes were used to generate V₁ and V₂ as shown in FIG. 3. The mean velocity flow was allowed to reach steady state before the alternating voltages were applied. The DC voltages are switched at frequencies ranging from 0.5 Hz to 10 Hz.

The layout of the inlet and outlet channels for purposes of the Examples below is a perpendicular inlet intersecting with a main channel as shown in FIGS. 1 and 2. In one example from experimental practice, the two inlet fluids are initially identical aqueous solutions, one inlet fluid is deionized water and the other inlet fluid is deionized water with a minimal amount of rhodamine dye for visualization purposes. Lateral mixing was observed using a commercial fluorescence microscope.

The following examples illustrate the various embodiments of the present invention. The results in all the Examples are based on numerical simulations using the numerical simulation methods described above.

### Example 1

In this Example, the rate of fluid flow was maintained constant in the first inlet channel and in the second inlet channel, and therefore the rate of flow was not pulsed. Two different flow rates are exemplified.

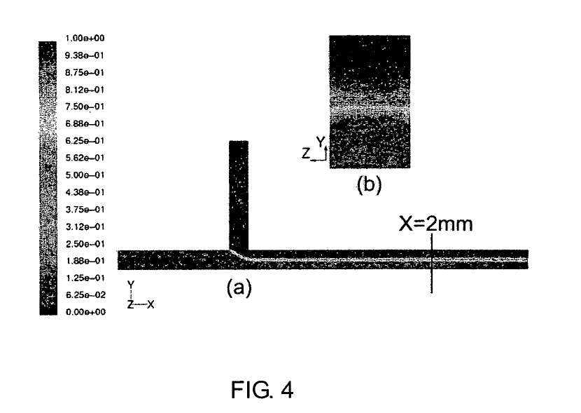

The first flow rate in each inlet channel is 1 mm/s, corresponding to a Reynolds number of 0.3. FIG. 4 shows the numerical simulation results of a control case, in which a constant mean velocity of 1 mm/s is imposed in both inlets. and shows very little mixing between the inlet fluids. The contour levels of the mass fraction of liquid A (coming from the in-line) (a) in the XY-plane at half the depth of the channel, and (b) in the YZ-plane at 2 mm downstream of the confluence. In all color contour levels of the mass fraction, a mass fraction of one is represented by red, thus visualizing liquid A while a mass fraction of zero is pictured in dark blue, corresponding to liquid B. Most of the lower half of the cross section in FIG. 4b exhibits a mass fraction of one indicating the presence of liquid A alone, while most of the upper half of the cross section shows a mass fraction of zero, indicating the presence of liquid B alone. The mixing zone is confined to a narrow band around the horizontal interface. The band is narrower near the plane of symmetry, indicating that there is less mixing at half the channel depth. This is due to the higher velocity in the middle of the channel and the corresponding shorter contact time, than near the walls of the channel. In this case, the degree of mixing, as defined in Equation 2, is equal to 0.12.

The second flow rate in each inlet is 8.5 mm/s, corresponding to the higher Reynolds number of 2.55. This corresponds to the peak pulse velocity in the Examples below. At peak velocity, even less mixing is present at 2 μm past the confluence, even as measured by the degree of mixing (Equation 2), which in this case, was found to be 0.08. At this higher mean flow velocity, the two liquids have less time to inter-diffuse as they travel side by side from the confluence to the cross-section of evaluation, i.e. 2 mm downstream.

### Example 2

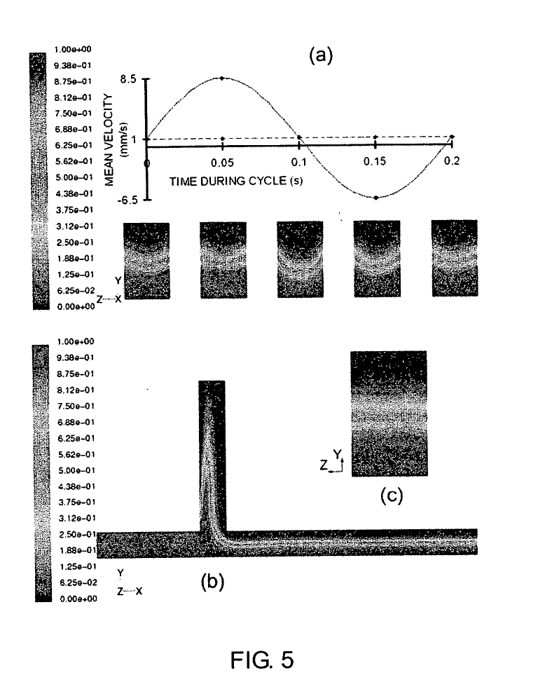

In this Example, the rate of fluid flow in the first inlet was varied periodically with time to create a volumetric perturbation while maintaining the rate of fluid flow constant in the second inlet. While the mean (i.e. cross-section spatially averaged) velocity of liquid A is the same as in Example 1 (1 mm/s), the mean velocity of liquid B in its inlet channel is forced to be 1.0+7.5 sin (31.416 t) mm/s. The temporally averaged velocity of liquid B over an integer number of pulsing periods remains constant, equal to 1 mm/s. FIG. 5a includes a time series of images that reveal how the interface stretches during a pulse cycle in the YZ-plane, with its curvature being a function of time during the pulse cycle. Such curvature allows liquid B to penetrate into liquid A (and vice versa) in the shape of a finger whose width coincides with that of the channel in the z-direction.

Pulsation of the interface between both fluids increases the extent of mixing, leading to a degree of mixing in this case, 0.22, which is 79% greater than the value for the constant flow rate. While there is considerable change during a cycle at a cross section located only 0.25 mm downstream of the confluence, there is limited variation through a pulse cycle at 2 mm downstream. The degree of mixing, which is calculated at 2 mm downstream, varies by less than 1% through each pulse cycle. FIG. 5b shows the levels of mass fraction in the XY-plane at half the channel depth.

The spike of liquid A entering into the inlet of liquid B is clearly visible in FIG. 5, although it is confined to the left part of the channel. Limited mixing occurs from left to right and vice versa. Separation between the two streams persists in the outlet channel. FIG. 5c displays the levels of mass fraction in a cross-section 2 mm downstream from the confluence, where the data is recorded. At that location, the interface is almost flat and time independent, and the thickness of the mixing zone is slightly greater than what it was upstream at X=0.25 mm as shown in FIG. 5a.

The effect of the amplitude of the pulses on the mixing efficiency is illustrated. With a double pulse amplitude, 15 mm/s, at a frequency of 5 Hz, the same degree of mixing was observed. Doubling the pulse amplitude causes the pulse volume to extend beyond a distance of 3 mm downstream. This Example demonstrates the maximum allowable amplitude, beyond which the pulses would enter upstream and/or downstream process chambers and possibly interfere with the proper operation of the cassette.

### Example 3

The rate of fluid flow in the first inlet channel and second inlet channel were varied periodically with time. When the fluid flow rate was pulsed in both inlets in phase with each other, the degree of mixing decreased as compared to the degree of mixing when one flow rate is pulsed and the other flow rate is maintained constant. When the two fluids are pulsed, the two fluids are basically flowing side by side, albeit in both forward and backward direction with minimal stretching of the interface.

A phase difference between the pulses was maintained, while maintaining all other parameters (amplitude, frequency) constant. The mean velocity of liquid B in its inlet channel is imposed to be 1.0+7.5 sin (31.416 t) mm/s while that of liquid A is forced to have the expression 1.0+7.5 sin (31.416 t+3.1416) mm/s or 1.0+7.5 sin (31.416 t+15.7) mm/s, leading to a phase difference of 90 degrees or 180 degrees (anti-phase). The flux weighted degree of mixing is found to be significantly higher than in all previous cases, 0.59 and 0.56 respectively. During each cycle, the degree of mixing varies by ±4% and 2% respectively.

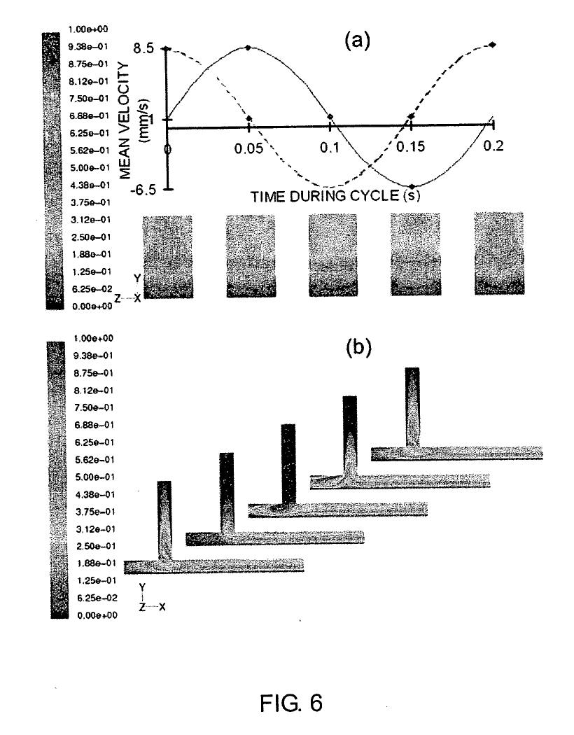

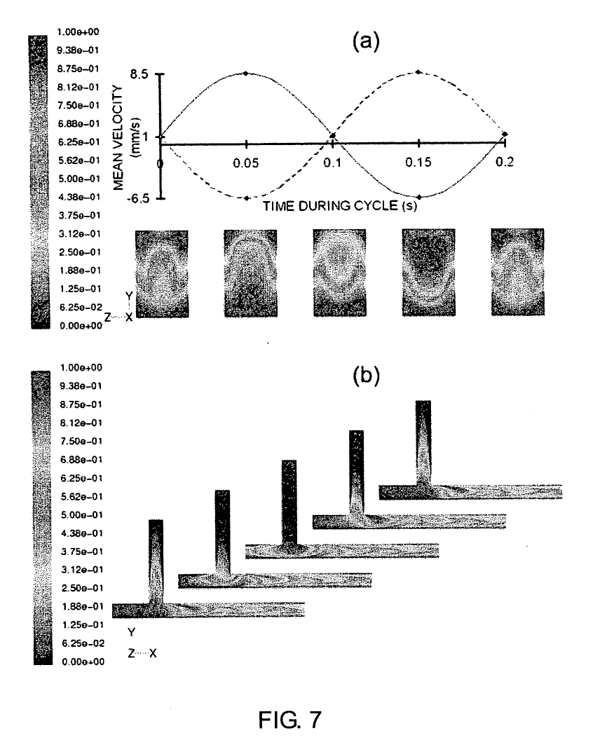

FIGS. 6 and 7 display the contour plots of the mass fraction in the XY- and YZ-planes with the two inlet flows pulsed at 90 degrees phase difference (FIG. 6) and when the inlet flows are pulsed at 180 degrees phase difference (FIG. 7). The 90 degree phase difference leads to slightly better mixing. FIG. 6b indicates that good mixing occurs very close to the confluence region and persists in the outlet channel.

### Example 4

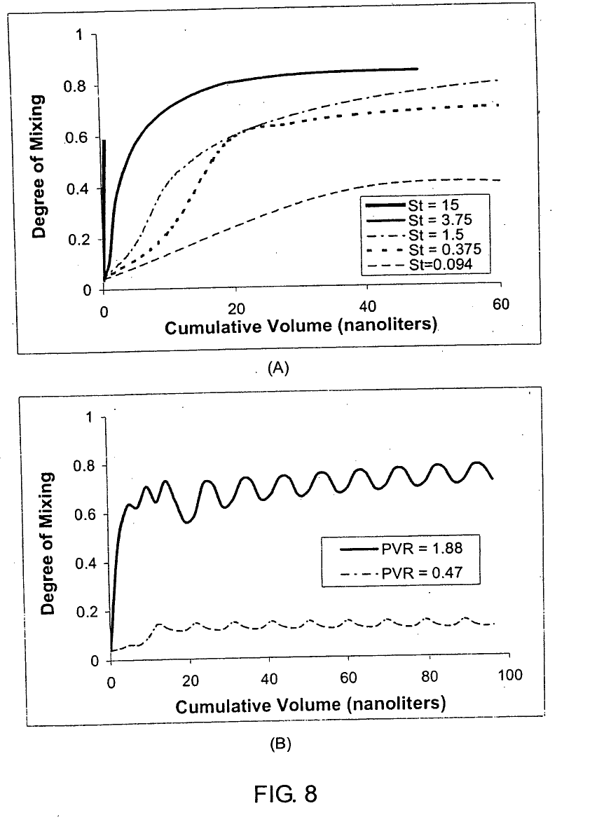

For the 90 degrees phase pulsing of, FIG. 8 illustrates the degree of mixing as a function of the cumulative volume for various Strouhal numbers at a PVR of 1.88 and two PVR's at St=0.375. The cumulative volume is the total volume of fluid which has traveled through the confluence region since pulsing was initiated. FIG. 8 shows that both the PVR and Strouhal numbers affect the degree of mixing. For this Example 4, the device of FIG. 1(c) was used.

### SUMMARY

The degree of mixing was quantified by statistically analyzing the concentration of the liquid from one of the inlets at all cells in a cross-section 0.5 mm downstream of the confluence. The base flow rate from both inlets is set to be the same so that the ideal concentration, i.e. for a completely mixed solution, was 0.50 in every cell. The deviation about a mean would yield the variation in concentration; a value of 0 would indicate perfect mixing. The degree of mixing is given by,

$$Degree of Mixing = 1 - \frac{\sqrt{{\sum }_{i = 1}^{n} \frac{{( {x}_{i} - μ )}^{2}}{n} ( \frac{{q}_{i}}{{q}_{mean}} )}}{μ} \qquad ( 2 )$$

where n represents the number of cells in the cross-section, xᵢ is the concentration in the i^{th} cell, μ is the mean concentration which equals 0.50, qᵢ represents the flow rate in the i^{th} cell and qₘₑₐₙ is the mean flow rate of all the cells. Table 1 sets forth the degree of mixing for various treatments using the device of FIG. 1(a).

TABLE 1

| Treatment | Degree of Mixing |
|---|---|
| No Pulsing | |
| Constant Flow at .5 mm/s | 0.08 |
| Pulsing from the perpendicular inlet | |
| Standard pulsing | 0.22 |
| Twice the Amplitude | 0.22 |
| Standard Pulsing in channel half as deep | 0.21 |
| Pulsing from both inlets | |
| Standard pulsing, in phase | 0.19 |
| 90 degrees phase difference | 0.59 |
| 180 degrees phase difference | 0.56 |
| Irrational frequency ratio | 0.52 |

While the present invention has been described with reference to specific embodiments, it should be understood to those skilled in the art that changes may be made without departing from the true spirit and scope of the invention. In addition, many modifications may be made to adapt the methods and devices of the present invention within the objective, scope and spirit of the invention. All such modifications are intended to be within the claims that follow.

1. A method of mixing two or more fluids, said method comprising the steps of:
applying a perturbation to a first fluid selected from the two or more fluids, wherein the perturbation to the first fluid pulses and reverses the flow of the first fluid;
applying a perturbation to a second fluid selected from the two or more fluids, wherein the perturbation to the second fluid pulses the flow of the second fluid; and
bringing into contact the first fluid and the second fluid with the remaining fluids to cause the two or more fluids to mix.

2. The method of claim 1, wherein the perturbation to the second fluid reverses the flow of the second fluid.

3. The method of claim 1, wherein the perturbation to the first fluid and the perturbation to the second fluid are in phase.

4. The method of claim 1, wherein the perturbation to the first fluid and the perturbation to the second fluid are out of phase.

5. The method of claim 1, wherein the perturbation to the first fluid and the perturbation to the second fluid are at the same frequency.

6. The method of claim 1, wherein the perturbation to the first fluid and the perturbation of the second fluid are at different frequencies.

7. The method of claim 1, wherein the perturbation to the first fluid and the perturbation to the second fluid are periodic.

8. The method of claim 1, wherein the perturbation to the first fluid and the perturbation to the second fluid are non-periodic.

9. The method of claim 1, wherein the perturbation to the first fluid and the perturbation to the second fluid are pressure-induced perturbations.

10. The method of claim 1, wherein the perturbation to the first fluid and the perturbation to the second fluid are displacement-induced perturbations.

11. The method of claim 1, wherein the perturbation to the first fluid and the perturbation to the second fluid are electrically-induced perturbations.

12. A method of mixing a first fluid and a second fluid, in a device comprising a first inlet channel, a second inlet channel and an outlet channel, wherein the first inlet channel and the second inlet channel intersect at a confluence region in fluid communication with the outlet channel, said method comprising the steps of:
flowing a first fluid into the first inlet channel;
flowing a second fluid into the second inlet channel;
applying a perturbation to the first fluid, wherein the perturbation to the first fluid pulses and reverses the flow of the first fluid;
applying a perturbation to the second fluid, wherein the perturbation to the second fluid pulses the second fluid; and
bringing into contact the first fluid and the second fluid to cause the first fluid and the second fluid to mix; and
flowing a mixture of the first fluid and the second fluid into the outlet channel.

13. The method of claim 12, wherein the perturbation to the second fluid reverses the flow of the fluid.

14. The method of claim 12, wherein the perturbation to the first fluid and the perturbation to the second fluid are in phase.

15. The method of claim 12, wherein the perturbation to the first fluid and the perturbation to the second fluid are out of phase.

16. The method of claim 12, wherein the perturbation to the first fluid and the perturbation to the second fluid are periodic.

17. The method of claim 12, wherein the perturbation to the first fluid and the perturbation to the second fluid are non-periodic.

18. The method of claim 12, wherein the perturbation to of the first fluid and the perturbation to the second fluid are at the same frequency.

19. The method of claim 12, wherein the perturbation to the first fluid and the perturbation to the second fluid are at different frequencies.

20. The method of claim 12, wherein the perturbation to the first fluid and the perturbation to the second fluid are pressure-induced perturbations.

21. The method of claim 12, wherein the perturbation to the first fluid and the perturbation to the second fluid are displacement-induced perturbations.

22. The method of claim 12, wherein the perturbation to the first fluid and the perturbation to the second fluid are electrically-induced perturbations.

23. A device for mixing a first fluid and a second fluid, wherein said mixing comprises the steps of applying a perturbation to the first fluid and to the second fluid to induce a volumetric displacement in the first fluid and the second fluid and cause the first fluid and second fluid to mix, the device comprising:
a first inlet channel which serves as a conduit for the first fluid,
a second inlet channel which serves as a conduit for the second fluid,
a confluence region wherein the first inlet channel and the second inlet channel intersect, and the first fluid and the second fluid meet and mix,
wherein the confluence region is of substantially the same volume as the volumetric displacement of the first fluid or the second fluid, and
an outlet channel in fluid communication with the confluence region which serves as a conduit for the mixed first fluid and second fluid.

24. The device of claim 23, further comprising means for applying the perturbation to the first fluid and means for applying the perturbation to the second fluid.

25. The device of claim 24, wherein the perturbation to the first fluid and the perturbation to the second fluid are pressure-induced perturbations.

26. The device of claim 24, wherein the perturbation to the first fluid and the perturbation to the second fluid are displacement-induced perturbations.

27. The device of claim 24, wherein the perturbation to the first fluid and the perturbation to the second fluid are electrically-induced perturbations.
